(19) United States
(12) Patent Application Publication
(10) Pub. No.: US 2009/0021478 A1
(43) Pub. Date: Jan. 22, 2009

(54) SWITCHING DEVICE AND METHOD FOR A PORTABLE DISPLAY PRODUCT

(76) Inventors: Wen-Jing Lin, Taoyuan County (TW); Chen-Hsuan Lo, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/017,050

(22) Filed: Jan. 21, 2008

(30) Foreign Application Priority Data
Jul. 19, 2007 (TW) 096126494

(51) Int. Cl. G06F 3/033

(52) U.S. Cl. 345/157

(57) ABSTRACT

A switching device and method for a portable display product includes a screen inserted on a body. A thicker handle is formed on one side of the body. Close to the center of one side of the screen, the handle disposes a main key, which is used most frequently. The side end of the handle is divided into an upper part and a lower part centered around the main key. Each part disposes a key unit, and the upper key unit is used more frequently. A control system disposed inside the body switches a display direction of the screen and function locations of the two key units for the convenience of one-handed operation.

### BACKGROUND OF THE INVENTION

1. Field of the Invention

The present invention relates to a portable display product, and more particularly, to a switching device and related switching method for a portable display product, which switches function locations of key units according to a display direction of a screen of the portable display product.

2. Description of the Prior Art

Due to portable display products having characteristics of thinness and lightness, which is suitable for carrying, they have become popular recently. In order to make the portable display products convenient for mobile use, operating designs are mainly designed for one-handed operation.

As shown in FIG. 1, a conventional electronic book 10 is taken as an example. The electronic book 10 includes a body 11, and a screen 12 is disposed in the center of the body 11. A main key 13, which is for a commonly used function, and a plurality of keys 14 are disposed on the right side of the screen 12 on the body 11, based on consumers' habits. The main key 13, such as an often-used five-directional key for adjusting frame shifts, is disposed in the center of the plurality of keys 14 based on ergonomics for the convenience of holding the electronic book 10 in a person's palm and for the ease of pushing the main key 13 using the thumb. In addition, the keys 14, such as a volume up key, a volume down key, a bookmark key, and a menu key are disposed in that order for the convenience of immediate access while reading.

However, because the location for holding the electronic book 10 with one hand is fixed and the moving range of the thumb is limited, it is harder to touch the other keys 14. Besides, the locations of the keys 14 are too far, and thus other fingers also cannot reach those keys 14. Only when a left hand is holding the other side of the body 11 can the right hand can move up and down to operate the other keys 14. Hence, the convenience for one-handed operation is lost. Moreover, conventional portable display products are usually designed for right-handed users. Thus, as a favor to left-handed or ambidextrous users, or for reading when changing hands, the conventional portable display products further provide a function for switching a display direction of the screen. That is, when the screen is reversed due to changing hands when reading, the display direction of the screen is also reversed through setting the screen menu with the keys for the convenience to reading. Nevertheless, because the locations of the keys are fixed, the sequence of the keys is reversed, which results in inconvenient operations. Therefore, there are still problems to be solved with the configuration and the operating methods of conventional portable display products.

### SUMMARY OF THE INVENTION

It is one of the objectives of the present invention to provide switching device for a portable display product, which is convenient for operating when changing hands through configurations of key units and switches of function locations of key units.

It is another objective of the present invention to provide a switching method for a portable display product, which is convenient for reading when changing hands by adjusting function locations of key units based on the display direction of the screen.

It is a further objective of the present invention to provide a switching device for a portable display product, which is convenient for holding and operating the portable display product with one hand through shapes and positions of function locations of key units.

The present invention provides a switching device for a portable display product, which includes a screen inserted on a body. A thicker handle, which has a thicker width than other parts of the body, is formed on one side of the body. Close to the center of one side of the screen, the handle disposes a main key, which is most often used. The side end of the handle is divided into an upper part and a lower part centered around the main key. Each part disposes a key unit, and the upper key unit is used more frequently. A control system disposed inside the body for switching a display direction of the screen and function locations of the two key units.

The control system includes a micro-processing unit for controlling a display-switching unit to switch the display direction of the screen and for controlling a key-switching unit to switch the function locations of the two key units. The control system can start switching operations of the micro-processing unit by triggering a switch via a menu on the screen or a switch disposed on the body. The control system can detect a locating direction of the portable display product for automatically starting the switching operations of the micro-processing unit by a sensing device.

The present invention provides a switching method for a portable display product. The method includes the following steps. First, detecting a locating direction of the portable display product (i.e., determining whether the locating direction, which is an angle formed between the portable display product and a gravity direction, is greater than a predetermined value). When the locating direction is not greater than the predetermined value, the step of detecting the locating direction is repeated. When the locating direction is greater than the predetermined value, switching a display direction and then swapping function locations of a first key unit and a second key unit. Finally, ending the switching method.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram for operating a conventional electronic book.

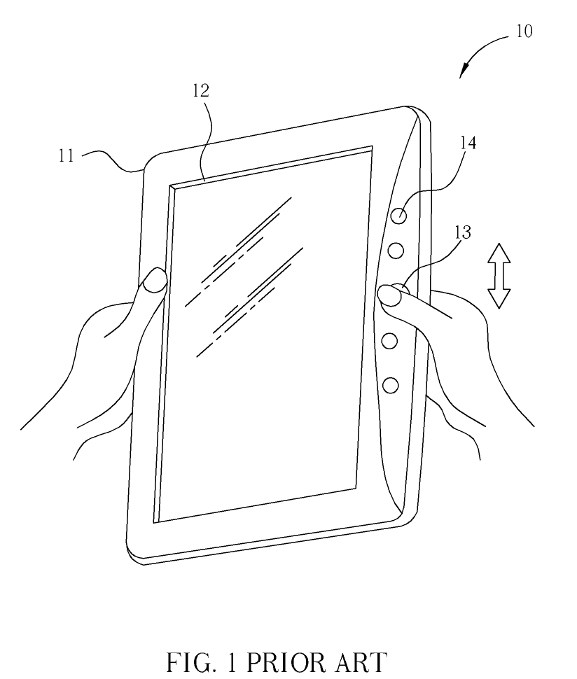

FIG. 2 is a diagram of a portable display product according to a first embodiment of the present invention.

FIG. 3 is a block diagram of the control system according to a first embodiment of the present invention.

FIG. 4 is a diagram for operating the portable display product by a right hand according to a first embodiment of the present invention.

FIG. 5 is a diagram for operating the portable display product by a left hand according to a first embodiment of the present invention.

FIG. 6 is a diagram of a portable display product according to a second embodiment of the present invention.

FIG. 7 is a block diagram of the control system according to a third embodiment of the present invention.

FIG. 8 is a flowchart for a switching method according to a third embodiment of the present invention.

### DETAILED DESCRIPTION

To achieve the abovementioned objectives, technology means and efficiencies adopted in the present invention are illustrated by preferred embodiments together with figures in the following.

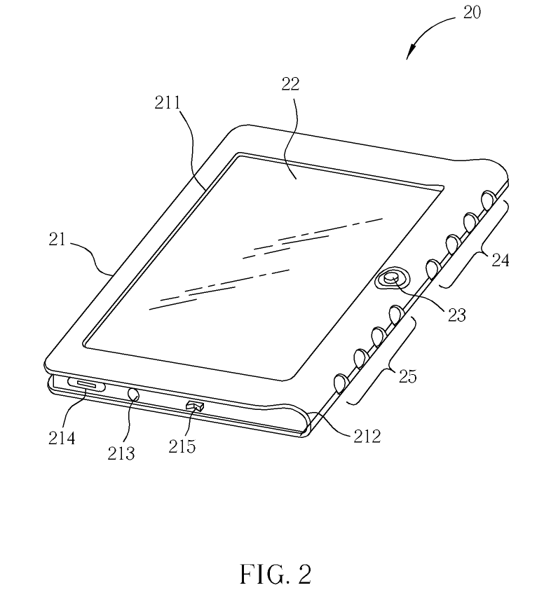

Please refer to FIG. 2. FIG. 2 is a diagram of a portable display product 20 according to a first embodiment of the present invention. The portable display product 20 uses an electronic book as an example, which includes a body 21, a screen 22, a main key 23, a first key unit 24, and a second key unit 25. The screen 22 is disposed on the body 21, and the main key 23 is disposed in the center of one side of the screen 22. The first key unit 24 and the second key unit 25 are respectively disposed on an upper part and a lower part of one side end, which is the same side end for disposing the main key 23, of the body 21 for reading operations.

The body 21 has a shape of a book, wherein a rectangular fillister 211 is disposed on an upper surface of the body 21 and the screen 22 is inserted into the fillister 211. An arc handle 212 is formed in one end of the body 21 near a long side of the screen 22, which has a thicker width than other parts of the body 21 for the convenience of holding by palms. The handle 212 disposes the main key 23 on the same surface as the screen 22 close to the center of the long side of the screen 22, which is a five-directional key often used. Therefore, it's easy for pushing and operating the main key 23 by the thumb when holding the handle 212 by the palm.

The side end of the handle 212 is divided into an upper part and a lower part centered around the main key 23, wherein the first key unit 24 with a row of keys is disposed in the upper part and the second key unit 25 with another row of keys is disposed in the lower part for easy reach by other fingers, such as a forefinger. The number of keys of the first key unit 24 and the second key unit 25 can be adjusted based on product demands. In this embodiment, each of the key unit has four keys. The four keys of the first key unit 24 are respectively a volume up key, a volume down key, a bookmark key, and a menu key used in more frequent situations. The four keys of the second key unit 25 are respectively an escape key, a refresh key, a pause key, and a stop key used in less frequent situations. On a lower side of the body 21 further disposes a headphone jack 213, an I/O connection interface 214, and a power switch 215.

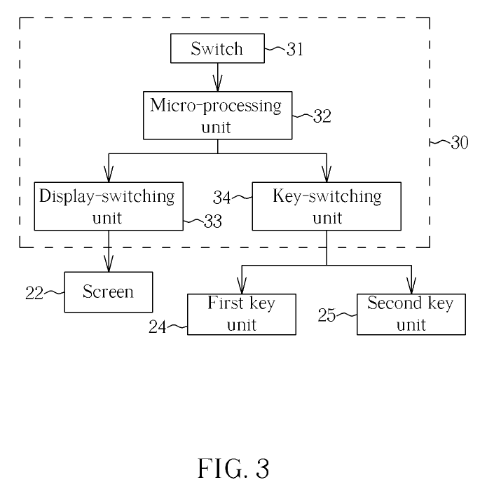

As shown in FIG. 3, which is a control system 30 disposed inside the portable display product 20. The control system 30 includes a switch 31, a micro-processing unit 32, a display-switching unit 33, and a key-switching unit 34. The portable display product utilizes a menu on the screen 22 for inverting the display direction of the screen 22 and for simultaneously switching the function locations of the two key units to start the switch 31 of the control system 30. A signal, which signals the locating direction of the portable display product 20, is outputted to the micro-processing unit 32. The micro-processing unit 32 respectively transmits switching signals to the display-switching unit 33 and to the key-switching unit 34, for controlling the display-switching unit 33 to rotate the display direction of the screen 22 in 180 degrees and for controlling the key-switching unit 34 to swap the function locations of the first key unit 24 and the second key unit 25.

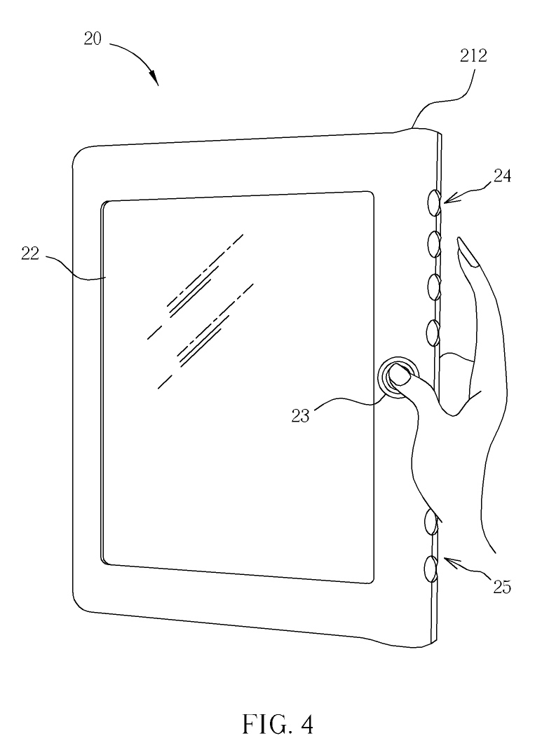

When holding the portable display product 20 in the right hand, as shown in FIG. 4, the palm holds the thicker handle 212 and is substantially near the second key unit 25 such that the thumb touches the main key 23 for moving pictures in the screen 22 when reading. If the volume up key, the volume down key, the bookmark key, or the menu key of the first key unit 24 needs to be adjusted, it's easy to touch only the first key unit 24 by holding with the other fingers and moving the forefinger. Therefore, the assistance of another hand is not necessary and one-handed operations are sufficient.

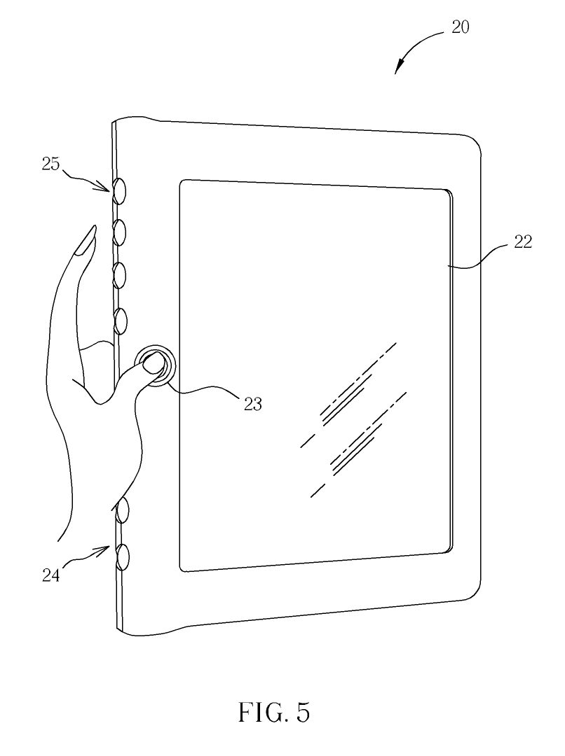

If it is necessary to hold the portable display product 20 in the left hand, the user can utilize the right thumb to touch the main key 23 to show the menu on the screen 22. And via the menu on screen 22, the display direction of the screen 22 is inverted and the function locations of the first key unit 24 and the second key unit 25 are simultaneously swapped to start the switch 31 of the control system 30. Therefore, the function locations that are used more frequently are changed as the display direction of the screen 22 is changed. The position of the portable display product 20 after switching is shown in FIG. 5: the screen 22 is inverted and the key units are switched to the left side. The palm of the left hand holds the thicker handle 212 and is substantially near the first key unit 24 such that the left hand thumb touches the main key 23 for moving pictures in the screen 22 when reading. Because the functions of the first key unit 24 and the second key unit 25 have already swapped, the function locations of the first key unit 24 and the second key unit 25 are changed. Therefore, the key unit that is used in more frequent situations is always located in a position that can easily be touched by the forefinger for the convenience of one-handed operation.

Hence, the switching device and related method for a portable display product disclosed in the present invention provides the convenience of one-handed operation when reading, by disposing the key in the position that can be easily reached by the forefinger together with switching the display direction of the screen and adjusting the function locations of the key units. Furthermore, the switching device for a portable display product disclosed in the present invention is suitable for both right-handed and left-handed users, because the display direction of the screen and the function locations of the key units can be adjusted. Thus, only the product with one direction needs to be developed, which can save development costs.

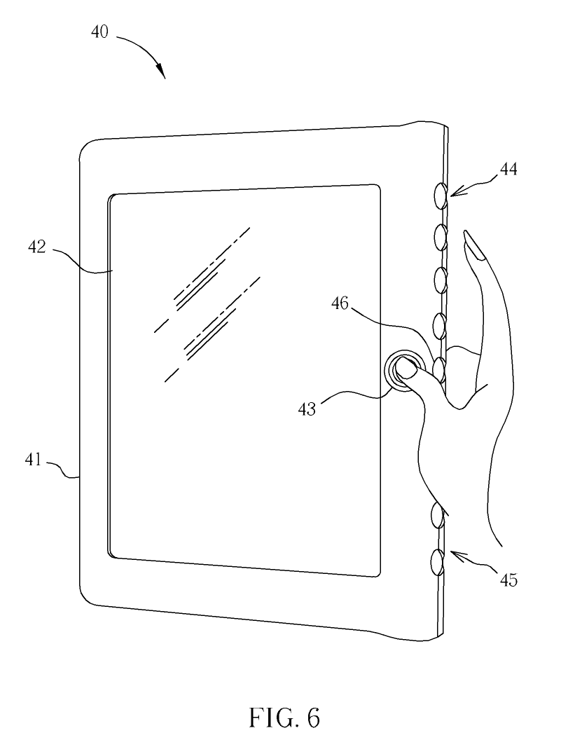

FIG. 6 is a diagram of a portable display product according to a second embodiment of the present invention. In this embodiment, the portable display product 40 includes a body 41, a screen 42, a main key 43, a first key unit 44, and a second key unit 45, which have the same structures and the same functions as the body 21, the screen 22, the main key 23, the first key unit 24, and the second key unit 25 shown in the first embodiment. The major difference between them is that a switching key 46 is disposed on the body 41 for starting the switch of the control system to control to switch the display direction of the screen 43 and to control to switch the function locations of the first key unit 44 and the second key unit 45. The switching key 46 can be disposed near the main key 43 or between the first key unit 44 and the second key unit 45 for convenience. Therefore, a complex process for setting the menu can be avoided by setting the switch of the display direction of the screen and the swap of the function locations of the two key units by the switching key 46 easily accessible.

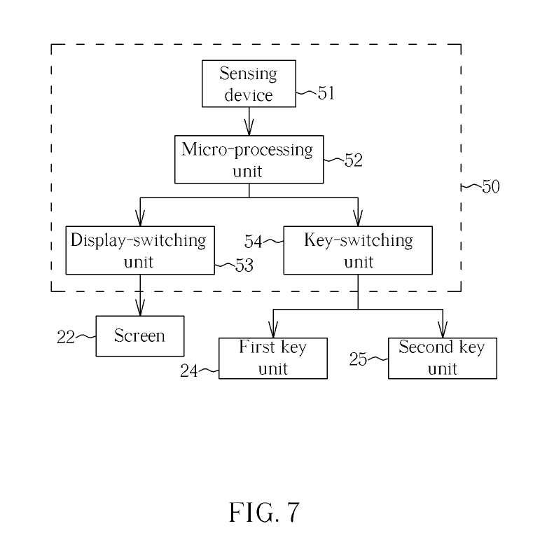

FIG. 7 is a block diagram of the control system 50 according to a third embodiment of the present invention. The architecture of the control system 50 is similar to the control system 30 of the first embodiment of the present invention. The difference between them is that the control system 50 is used for automatically detecting to control the switch of the display direction of the screen and to control the switch of the function locations of the first key unit and the second key unit. The control system 50 is disposed inside the portable display product and includes a sensing device 51, a micro-processing unit 52, a display-switching unit 53, and a key-switching unit 54. The sensing device 51 of the control system 50 is used for detecting a locating direction of the portable display product, such as an upright direction or a reverse direction. After detecting, a signal that indicates the locating direction is outputted to the micro-processing unit 52. The micro-processing unit 52 compares the locating direction with a predetermined value and then respectively transmits switching signals to the display-switching unit 53 and to the key-switching unit 54, for controlling the display-switching unit 53 to rotate the display direction of the screen 180 degrees and for controlling the key-switching unit 54 to swap the function locations of the first key unit and the second key unit.

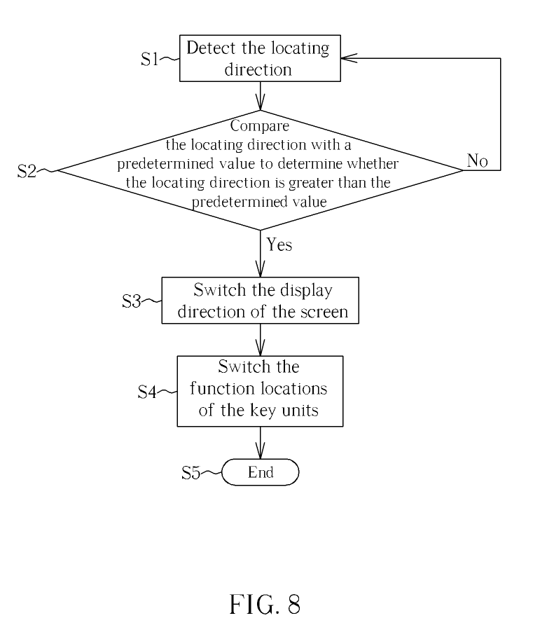

The detailed steps for how the abovementioned control system 50 controls the portable display product to switch the display direction of the screen and to switch the function locations of the key units are shown in FIG. 8, which is a flowchart for a switching method according to a third embodiment of the present invention. First, in the step S1, the sensing device detects the locating direction of the portable display product, which is an angle formed between the portable display product and the direction of gravity, and then outputs a signal that stands for the locating direction. In the step S2, the micro-processing unit receives the signal for the locating direction and determines whether the locating direction is greater than a predetermined value. The predetermined value can be set to 90 degrees, which represents that the portable display product has rotated to the horizontal status. If the locating direction is not greater than the predetermined value, the control system doesn't switch the display direction of the screen and the function locations of the key units and goes back to the step S1 for continuing to detect the locating direction. If the locating direction is greater than the predetermined value, which means the portable display product has tilted sufficiently and enters a reverse (switched) status. Thus, enter Step S3: the control system controls the display-switching unit to switch the display direction of the screen and then enters Step S4. The control system controls the key-switching unit to swap the function locations of the first key unit and the second key unit and enters the step S5 to end the stage of the flowchart, and then enters another stage to continue detecting the locating direction.

Therefore, the switching method for a portable display product disclosed in the third embodiment of the present invention provides the convenience of one-handed operation when reading by disposing the main key in a position that can be easily reached by the forefinger, detecting the locating direction of the portable display product, switching the display direction of the screen, and adjusting the function locations of the key units.

These embodiments above are presented merely for describing features of the present invention, and in no way should be considered to be limitations of the scope of the present invention. It will be obvious to those skilled in the art that various modifications may be made without departing from the spirit of the present invention.

Those skilled in the art will readily observe that numerous modifications and alterations of the device and method may be made while retaining the teachings of the invention.

What is claimed is:

1. A switching device for a portable display product, comprising:
a body, comprising a screen inserted on the body and two key units respectively disposed on an upper part and a lower part of one side end of the body, wherein the upper key unit has keys used more frequently; and
a control system, disposed inside the body, for switching a display direction of the screen and function locations of the two key units.

2. The switching device for the portable display product of claim 1, wherein a handle, which has a thicker width than other parts of the body, is formed on one side of the body.

3. The switching device for the portable display product of claim 2, wherein the handle is an arc.

4. The switching device for the portable display product of claim 2, wherein the handle disposes a main key on a same surface of the body as the screen, close to the center of one side of the screen, the main key being a five-directional key to be used frequently.

5. The switching device for the portable display product of claim 4, wherein the side end of the handle is divided into an upper part and a lower part based on the main key as the center, a first key unit used in more frequent situations is disposed in the upper part, and a second key unit that used in less frequent situations is disposed in the lower part.

6. The switching device for the portable display product of claim 5, wherein each of the first key unit and the second key unit has four keys.

7. The switching device for the portable display product of claim 6, wherein the four keys of the first key unit are a volume up key, a volume down key, a bookmark key, and a menu key, respectively.

8. The switching device for the portable display product of claim 6, wherein the four keys of the second key unit are an escape key, a refresh key, a pause key, and a stop key, respectively.

9. The switching device for the portable display product of claim 1, wherein the control system comprises a micro-processing unit for controlling a display-switching unit to switch the display direction of the screen and for controlling a key-switching unit to switch the function locations of the two key units.

10. The switching device for the portable display product of claim 9, wherein the control system comprises a switch for starting switching operations of the micro-processing unit.

11. The switching device for the portable display product of claim 10, wherein the control system sets to start the switch through a menu on the screen of the portable display product.

12. The switching device for the portable display product of claim 10, wherein a switching key is disposed on the body for starting the switch of the control system.

13. The switching device for the portable display product of claim 12, wherein the switching key is disposed near the main key.

14. The switching device for the portable display product of claim 12, wherein the switching key is disposed between the two key units.

15. The switching device for the portable display product of claim 9, wherein the control system comprises a sensing device, for detecting a locating direction of the portable display product for automatically starting the switching operations of the micro-processing unit.

16. A switching method for the portable display product, the method comprising the following steps:
(a) detecting a locating direction of the portable display product;
(b) determining whether the locating direction is greater than a predetermined value; when the locating direction is not greater than the predetermined value, going back to the step (a); when the locating direction is greater than the predetermined value, going to a next step;
(c) switching a display direction;
(d) swapping function locations of a first key unit and a second key unit; and
(e) ending the switching method.

17. The switching method for the portable display product of the claim 16, wherein the locating direction is an angle formed between the portable display product and a direction of gravity.

18. The switching method for the portable display product of the claim 16, wherein the predetermined value is 90 degrees.
